(19) United States
(12) Patent Application Publication
(10) Pub. No.: US 2010/0038985 A1
(43) Pub. Date: Feb. 18, 2010

(54) BRUSHLESS DC MOTOR, MAGNETIZING METHOD THEREOF AND WASHING MACHINE HAVING THE SAME

(76) Inventors: Jang-Ho Shim, Seoul (KR); Seung-Suk Oh, Seoul (KR); Byoung-Wook Min, Seoul (KR)

Correspondence Address: MCKENNA LONG & ALDRIDGE LLP, 1900 K STREET, NW, WASHINGTON, DC, 20006, US

(21) Appl. No.: 12/448,730

(22) PCT Filed: Sep. 19, 2007
(86) PCT No.: PCT/KR2007/004565

§ 371 Date: Jul. 2, 2009

(30) Foreign Application Priority Data
Jan. 4, 2007 (KR) 10-2007-0001070

(51) Int. Cl. H02K 1/27; H02K 15/03; H01F 13/00

(52) U.S. Cl. 310/156.43; 29/598; 335/284

(57) ABSTRACT

Disclosed is a brushless DC motor, a magnetizing method thereof and a washing machine having the same. The brushless DC motor, comprising: a stator, and a rotor having a plurality of magnetic poles with a same thickness, wherein each of the magnetic poles is magnetized such that a magnetic flux density of an air gap is high at a central portion of each of the magnetic poles, compared to the magnetic flux density at both ends of each of the magnetic poles. Accordingly, a manufacturing cost can be reduced, a manufacturing process can be facilitated, and vibration and noise can be reduced.

### TECHNICAL FIELD

The present invention relates to a brushless DC motor, a washing machine having the same and a magnetizing method thereof, and more particularly, to a brushless DC motor which can reduce noise and vibration by having a high magnetic flux density of an air gap at a central portion of a magnetic pole and by gradually reducing the magnetic flux density toward both ends of the magnetic pole, a washing machine having the same and a magnetizing method thereof.

### BACKGROUND ART

FIG. 1 is a cross-sectional view illustrating a related art washing machine. FIG. 2 is an exploded perspective view illustrating a driving motor in FIG. 1. FIG. 3 is a diagram illustrating a magnetizing method of the driving motor in FIG. 1. As shown in FIG. 1, a washing machine includes a cabinet 10, an outer tub 20 disposed inside the cabinet 10, a rotating tub 30 rotatably mounted inside the outer tub 20, and a driving motor 40 for rotating the rotating tub 30.

An opening 12 and a door 14 are provided on a front surface of the cabinet 10. The outer tub 20 is supported by springs 22 and a damper 24 inside the cabinet 10. The rotating tub 30 is rotatably mounted inside the outer tub 20, and a drain passage 25 having a drain pump 27 is formed below the outer tub 20. The driving motor 40 for rotating the rotating tub 30 is disposed at a rear end of the outer tub 20.

As shown in FIG. 2, the driving motor 40 is implemented as a brushless DC motor that includes a stator 41 fixed to the outer tub 20, a rotor 51 rotatably disposed with a predetermined air gap from the stator 41, and a rotor position detecting unit 65 for detecting a rotation position of the rotor 51.

The stator 41 includes a stator core 43 having a plurality of teeth outwardly protruding from an outer surface thereof, and a stator coil 44 wound on the stator core 43. The rotor position detecting unit 65 is disposed at one side of the stator core 43 so as to detect the rotation position of the rotor 51, and is implemented as a hall sensor.

The rotor 51 includes a frame 53 rotatably disposed outside the stator 41, and a permanent magnet 63 disposed on an inner surface of the frame 53.

Meanwhile, the frame 53 is formed in a cylindrical shape having one open side. A rotation shaft 31 of the rotating tub 30 is rotatably coupled to the center of the frame 53. A shaft coupling portion 54 for coupling the rotation shaft 31 is formed at the center of the frame 53. Blades 55 are formed at a periphery of the shaft coupling portion 54 so as to accelerate the flow of air. The permanent magnet 63 having a circular ring type or a plurality of segments is integrally and rotatably coupled to the inner surface of the cylindrical portion of the frame 53. The permanent magnet 63 is magnetized such that different magnetic poles are alternatively arranged in a circumferential direction.

However, in such related art washing machine, the driving motor 40 is formed as an “outer rotor type motor” in which the rotor 51 is rotatably disposed outside the stator 41. Accordingly, it is difficult to apply a spiral core capable of reducing a material cost of the core to the manufacture of the stator core 43.

In addition, since the frame 53 of the rotor 51 is manufactured to have a cylindrical shape by pressing a thin steel plate, etc., the frame 53 has weak rigidity. On the other hand, the size of the frame 53 increases since it needs to be disposed outside the stator 41, thereby increasing vibration and noise.

Further, since the frame 53 of the rotor 51 is structured to cover the stator 41, a temperature of the stator 41 easily increases. Accordingly, the blades 55 are formed at the frame 53 to cool the stator 41, thereby causing more vibration and noise.

As shown in FIG. 3, the magnetization is performed by disposing the permanent magnet 63 between a magnetizing yoke 71 having a rectangular end portion 72a and a circular back yoke 73. Accordingly, the magnetic flux density of the air gap of each magnetic pole, as shown in a dotted line, is almost uniformly distributed at a central portion of each magnetic pole and both ends thereof. As a result, the magnetic force is rapidly changed, thereby increasing cogging torque, and thus to increase noise and vibration.

### Disclosure

### Technical Problem

Therefore, it is an object of the present invention to provide a brushless DC motor which can reduce noise and vibration, a washing machine having the same and a magnetizing method thereof.

It is another object of the present invention to provide a brushless DC motor which can reduce a manufacturing cost and facilitate its manufacture by having a high magnetic flux density of a permanent magnet at a central portion of a magnetic pole and by gradually reducing the magnetic flux density toward both ends thereof, a washing machine having the same and a magnetizing method thereof.

### Technical Solution

To achieve these and other advantages and in accordance with the purpose of the present invention, as embodied and broadly described herein, there is provided a brushless DC motor, comprising: a stator; and a rotor having a plurality of magnetic poles with a same thickness and disposed to be rotatable with respect to the stator, wherein each of the magnetic poles is magnetized such that a magnetic flux density of an air gap is high at a central portion of each of the magnetic poles, compared to the magnetic flux density at both ends of each of the magnetic poles.

Here, the rotor is formed as an inner-rotor type motor which is rotatably disposed inside the stator, and may further include a frame integrally formed with a magnetic pole coupling portion having an outer surface coupled to the magnetic pole, a hub concentrically disposed at a center of the magnetic pole coupling portion, and a plurality of rods for connecting the magnetic pole coupling portion and the hub.

And, the stator may include a stator core which is spirally and consecutively laminated in a thickness direction.

The magnetic pole of the permanent magnet may be formed as a permanent magnet having a ring shape or a plurality of segments having a circular arc shape.

And, the permanent magnet may be formed as an isotropic, neodymium (Nd) bonded magnet.

Further, according to another aspect of the present invention, there is provided a brushless DC motor, comprising: a stator having a stator core consecutively laminated in a spiral shape in a thickness direction; and a rotor having a frame rotatably disposed inside the stator and having a plurality of magnetic poles formed of the same thickness on an outer surface of the frame, wherein each of the magnetic poles is magnetized such that a magnetic flux density of an air gap is high at a central portion of each of the magnetic poles, compared to the magnetic flux density at both ends of each of the magnetic poles.

According to the present invention, there is provided a washing machine having the brushless DC motor.

According to the present invention, there is provided a magnetizing method of a brushless DC motor, comprising: forming a magnetic material to be magnetized as a permanent magnetic material with a same thickness; disposing a magnetizing yoke and a back yoke, respectively, such that an arc-shaped end portion having a center convexly protruding toward the magnetic material is disposed to at least one of an inner side and an outer side of the magnetic material to be magnetized; and magnetizing the permanent magnetic material by applying a high voltage to the magnetizing yoke.

### Advantageous Effects

According to the present invention, there is provided a brushless DC motor which can reduce vibration and noise by having a magnetic pole in which a magnetic flux density of an air gap has a sine-curve shape, and a washing machine having the same.

In addition, the permanent magnet forming the magnetic pole or the magnetic flux density of the air gap of the segment have a sine-curve shape, thereby facilitating the manufacture and reducing the manufacturing cost, rather than making a cross-section of the permanent magnet or each magnetic pole of the segment as a circular arc shape so as to form the magnetic flux density of the air gap in the sine-curve shape after magnetizing the permanent magnet or the segment.

Further, since the rotor is disposed to be rotatable inside the stator, a spiral core can be applied to the manufacture of the stator core, thereby reducing a material cost and facilitating the manufacture. However, in the related art manufacturing method, the stator core is formed by laminating a core sheet, thereby generating scraps a lot, and thus to increase a material cost and require high manufacturing cost and work effort.

In addition, since the rotor is configured to be rotated inside the stator, a size of the rotor may be reduced, a structure can be modified for concentricity and roundness, and mechanical rigidity can be enhanced.

Further, since the rotor is rotated inside the stator, the frame of the rotor does not cover the stator. Accordingly, there is no need to use the blades that increase noise and vibration, and vibration and noise generated when driving can be reduced overall.

### BRIEF DESCRIPTION OF THE DRAWINGS

The above and other objects, features, and advantages of the present invention will be made apparent form the following description of the preferred embodiments, given as nonlimiting examples, with reference to the accompanying drawings in which:

FIG. 1 is a cross-sectional view illustrating a related art washing machine;

FIG. 2 is an exploded perspective view illustrating a driving motor in FIG. 1;

FIG. 3 is a diagram illustrating a magnetizing method of the driving motor in FIG. 1;

FIG. 4 is a cross-sectional view illustrating a washing machine having a brushless DC motor according to one embodiment of the present invention;

FIG. 5 is an exploded perspective view illustrating the driving motor in FIG. 4;

FIG. 6 is a perspective view illustrating a manufacturing method of a stator core in FIG. 4;

FIG. 7 is a diagram illustrating a magnetizing method of a permanent magnet in FIG. 4;

FIGS. 8 and 9 are diagrams respectively illustrating a magnetizing method of the permanent magnet in FIG. 4;

FIG. 10 is a diagram comparing a torque profile of the driving motor in FIG. 4 with a torque profile of a related art driving motor;

FIG. 11 is a diagram comparing cogging torque profiles between the driving motor in FIG. 4 and the related art driving motor; and

FIG. 12 is a diagram comparing noise levels between the driving motor in FIG. 4 and the related art driving motor.

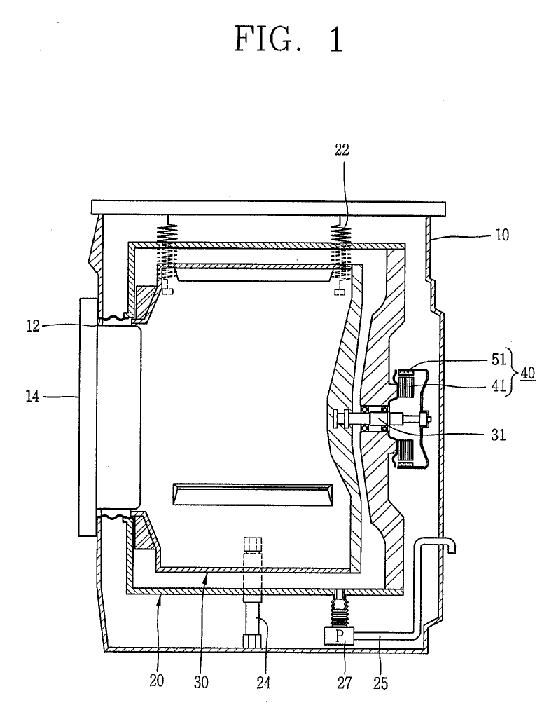

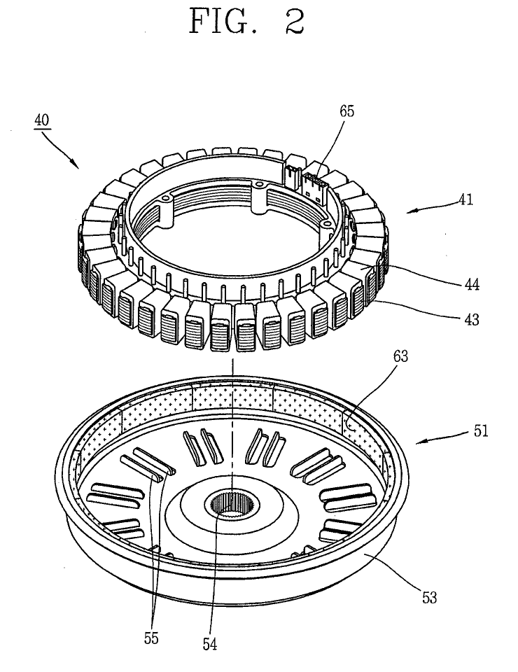

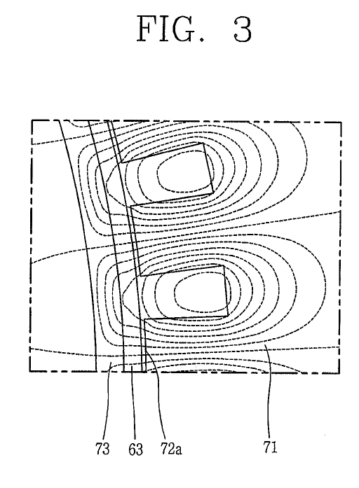

### MODE FOR INVENTION

Referring to FIG. 4, a washing machine having a brushless DC motor includes a cabinet 110, an outer tub 120 disposed inside the cabinet 110, a rotating tub 130 rotatably disposed inside the outer tub 120, and a driving motor 140 having a magnetic flux density of an air gap in a sine-curve shape and for rotating the rotating tub 130.

An opening 112 is formed at a front surface of the cabinet 110, and a door 114 is disposed at one side of the opening 112. The outer tub 120 for receiving washing water is supported by springs 122 and a damper 124 inside the cabinet 110. The rotating tub 130 is rotatably disposed inside the outer tub 120. A drain passage 125 having a drain pump 127 is positioned below the outer tub 120. The driving motor 140 is mounted at a rear end of the outer tub 120.

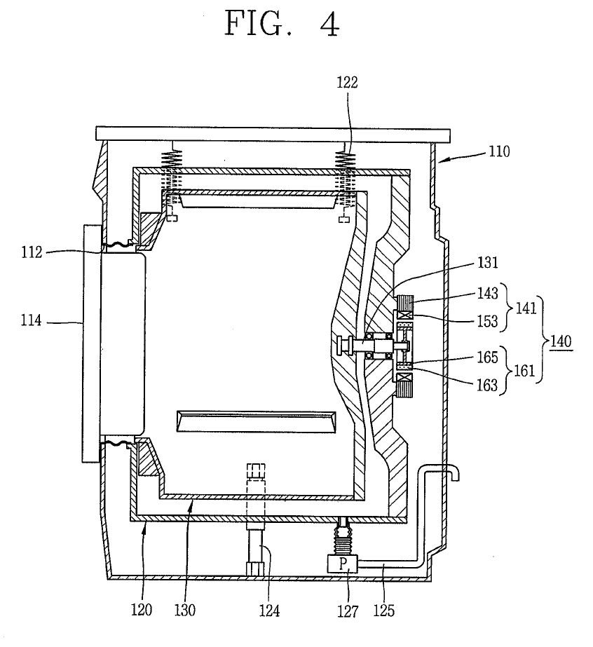

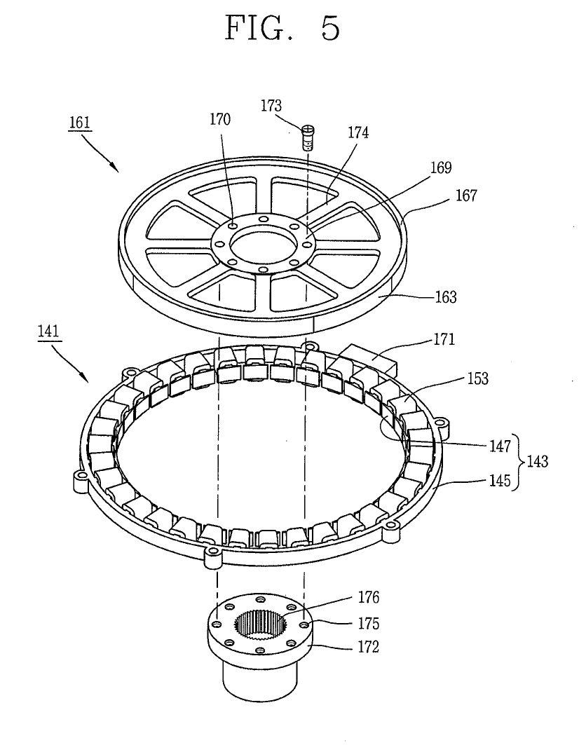

As shown in FIG. 5, the driving motor 140 is implemented as a brushless DC motor which includes a stator 141, a rotor 161 disposed to be rotatable with respect to the stator 141 having an air gap therebetween and having a permanent magnet 163 magnetized to have a magnetic flux density of the air gap in a sine-curve shape, and a rotor position detecting unit 171 for detecting a rotation position of the rotor 161. Here, that the radial magnetic flux density of the air gap has a sine-curve shape refers that the magnetic flux density is high at a center of each of the magnetic poles and gradually reduces toward both sides (or a boundary portion of the magnetic pole) of each of the magnetic poles. Accordingly, harmonic components that cause noise and vibration can be reduced. In addition, a rapid change in the magnetic force can be prevented, thereby reducing cogging torque that causes noise and vibration.

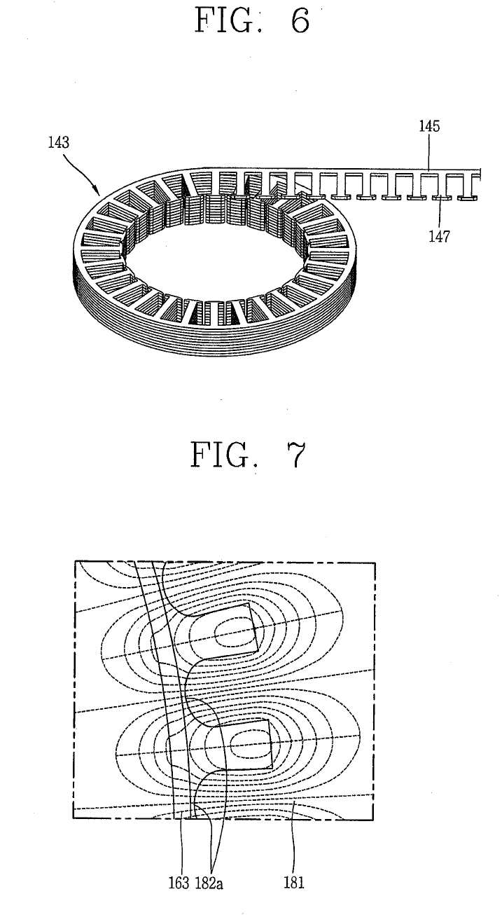

As shown in FIG. 5, the stator 141 includes a stator core 143 having a plurality of teeth 147 spaced from each other in a circumferential direction and protruding toward the center, and a stator coil 153 wound to the stator core 143. The stator core 143, as shown in FIG. 6, includes a long belt (strap)-shaped yoke 145, and a plurality of teeth 147 protruding from one side of the yoke 145 and spaced from each other at a predetermined pitch. And, the stator core 143 is formed as a “spiral core” that is spirally and consecutively wound in a thickness direction.

Meanwhile, the rotor 161 includes the permanent magnet 163, and a frame 165 having an outer surface coupled to the permanent magnet 163. The frame 165 is formed as a “solid type frame” which is integrally formed with a magnet supporting portion 167 having a cylindrical shape so as to couple the permanent magnet 163 to an outer surface thereof, a hub 169 concentrically disposed to the center of the magnet supporting portion 167, and a plurality of rods 174 for connecting the magnet supporting portion 167 and the hub 169. Accordingly, mechanical rigidity can be enhanced, thereby reducing noise and vibration. A plurality of through-holes 170 are penetratingly formed at the hub 169 such that a shaft supporting portion 172 can be coupled by a plurality of screws 173. A female thread portion 175 is formed in the shaft supporting portion 172, and a shaft coupling portion 176 is formed at a central portion of the shaft support portion 172 so as to be coupled to a rotation shaft 131 of the rotating tub 130.

The permanent magnet 163 is magnetized such that different magnetic poles are alternatively arranged in a circumferential direction. The permanent magnet 163 may be formed as an isotropic, neodymium (Nd) bonded magnet that has a uniform magnetic force in each direction such that a magnetic flux density has a sine-curve shape. Here, the permanent magnet 163 may have a circular ring shape or may be configured to divide the circumference into a plurality of segments having a circular arc shape and then dispose each segment on the same circumference.

Referring to FIG. 7, the permanent magnet 163 is magnetized by arranging a magnetizing yoke 181 having an arc-shaped end portion 182a at one side of the neodymium (Nd) bonded magnet 163, and by momentarily applying a high voltage. Then, the magnetic flux density of the air gap at the central portion of the arc-shaped end portion 182a becomes higher than that at both ends of the arc-shaped end portion 182a. Accordingly, the magnetic flux density of the air gap in a circumferential direction forms a sine curve.

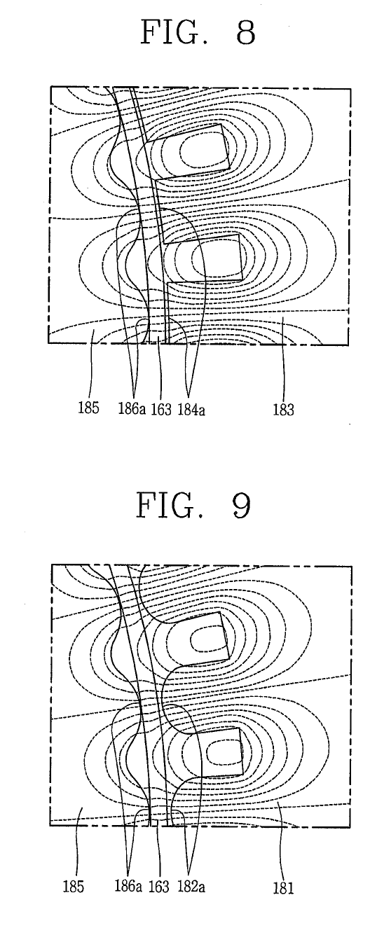

In addition, as shown in FIG. 8, a magnetizing yoke 183 having a rectangular end portion 184a is disposed at one side of the Nd bonded magnet 163, and a back yoke 185 having an arc shape end portion 186a is disposed at another side of the Nd bonded magnet 163, thereby being magnetized. Thus, the Nd bonded magnet 163 can have the magnetic flux density of the sine curve.

As shown in FIG. 9, a magnetizing yoke 181 having an arc shape end portion 182a is disposed at one side of the Nd bonded magnet 163, and a back yoke 185 having an arc shape end portion 186a is disposed at another side of the Nd bonded magnet 163, thereby being magnetized. Accordingly, the magnetic flux density of the air gap can form a sine curve.

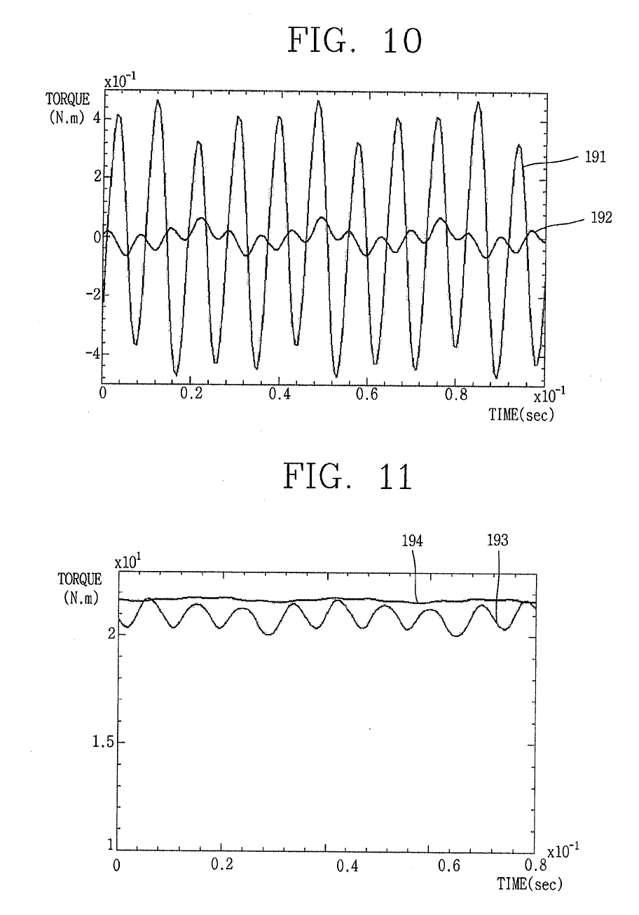

As shown in FIG. 10, the driving motor 140 having the above-described permanent magnet 163 has a smooth torque profile 192 close to almost a straight line, compared to the related art driving motor having a torque profile 191 of a sine curve. As shown in FIG. 11, unlike the related art driving motor having a cogging torque profile 193 of a large deviation, the driving motor 140 has a cogging torque profile 194 of a highly reduced deviation.

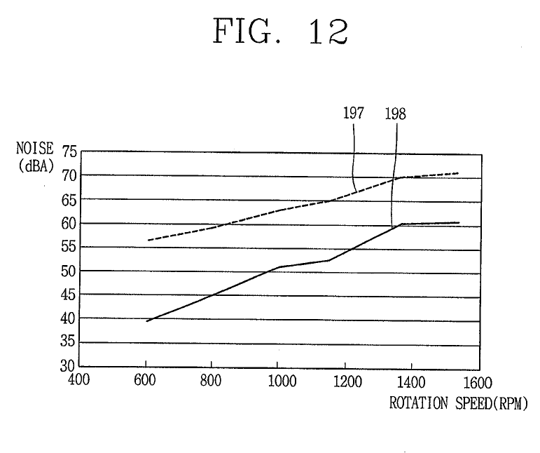

Further, it is observed that the noise level of the driving motor 140, as shown in a solid line 198 in FIG. 12, is decreased more than 10 dBA overall in the same rotation speed, compared to that of the related art driving motor as shown in a dotted line 197.

What is claimed is:

1. A brushless DC motor, comprising:
a stator; and
a rotor having a plurality of magnetic poles with a same thickness and disposed to be rotatable with respect to the stator,
wherein each of the magnetic poles is magnetized such that a magnetic flux density of an air gap is high at a central portion of each of the magnetic poles, compared to the magnetic flux density at both ends of each of the magnetic poles.

2. The brushless DC motor of claim 1, wherein the rotor is rotatably disposed inside the stator.

3. The brushless DC motor of claim 2, wherein the rotor further comprises:
a frame integrally formed with a magnetic pole coupling portion having an outer surface coupled to the magnetic pole, a hub concentrically disposed at a center of the magnetic pole coupling portion, and a plurality of rods for connecting the magnetic pole coupling portion and the hub.

4. The brushless DC motor of claim 2, wherein the stator includes a stator core which is spirally and consecutively laminated in a thickness direction.

5. The brushless DC motor of claim 4, wherein the stator core includes a long belt-shaped yoke, and a plurality of teeth protruding from one side of the yoke at a predetermined pitch.

6. The brushless DC motor of claim 1, wherein the magnetic pole is a permanent magnet having a ring shape.

7. The brushless DC motor of claim 6, wherein the permanent magnet is a neodymium (Nd) bonded magnet.

8. The brushless DC motor of claim 7, wherein the permanent magnet is an isotropic magnet.

9. The brushless DC motor of claim 1, wherein the magnetic pole is formed of a plurality of segments that are alternatively arranged in a circumferential direction so as to have different polarities.

10. The brushless DC motor of claim 1, wherein the magnetic flux density of the air gap of the magnetic pole in the circumferential direction forms a sine-curve.

11. A washing machine having the brushless DC motor of claim 1.

12. A brushless DC motor, comprising:
a stator having a stator core spirally and consecutively laminated in a thickness direction;
a rotor having a frame rotatably disposed inside the stator and having a plurality of magnetic poles formed on an outer surface of the frame with a same thickness,
wherein each of the magnetic poles is magnetized such that a magnetic flux density of an air gap is high at a central portion of each of the magnetic poles, compared to the magnetic flux density at both ends of each of the magnetic poles.

13. The brushless DC motor of claim 12, wherein the frame includes a magnetic pole coupling portion having an outer surface coupled to the magnetic pole, a hub concentrically disposed inside the magnetic pole coupling portion, and a plurality of rods for connecting the magnetic pole coupling portion and the hub.

14. The brushless DC motor of claim 13, wherein the hub is provided with a shaft supporting portion for coupling a rotation shaft.

15. A washing machine having the brushless DC motor of claim 12.

16. A magnetizing method of a brushless DC motor, comprising:
forming a magnetic material to be magnetized as a permanent magnetic material with a same thickness;
disposing a magnetizing yoke and a back yoke, respectively, such that an arc-shaped end portion having a center convexly protruding toward the magnetic material is disposed to at least one of an inner side and an outer side of the magnetic material to be magnetized; and
magnetizing the permanent magnetic material by applying a high voltage to the magnetizing yoke.
